(19) United States
(12) Patent Application Publication
(10) Pub. No.: US 2015/0193856 A1
(43) Pub. Date: Jul. 9, 2015

(54) APPARATUS AND METHOD FOR PROVIDING LIGHTING CONTENT

(71) Applicant: ELECTRONICS AND TELECOMMUNICATIONS RESEARCH INSTITUTE, Daejeon-city (KR)

(72) Inventors: Hyun-Seok KIM, Daejeon (KR); You-Jin KIM, Daejeon (KR); Dae-Ho KIM, Daejeon (KR); Hyun-Jong KIM, Chungcheongbuk-do (KR); Tae-Gyu KANG, Daejeon (KR)

(73) Assignee: ELECTRONICS AND TELECOMMUNICATIONS RESEARCH INSTITUTE, Daejeon-city (KR)

(21) Appl. No.: 14/291,111

(22) Filed: May 30, 2014

(30) Foreign Application Priority Data
Jan. 8, 2014 (KR) 10-2014-0002476

(51) Int. Cl. G06Q 30/06

(52) U.S. Cl. CPC G06Q 30/0633

(57) ABSTRACT

An apparatus and method for providing lighting content are disclosed. The apparatus for providing lighting content includes a lighting content creation control unit, a lighting content distribution/sales control unit, and a lighting content consumption control unit. The lighting content creation control unit creates lighting content. The lighting content distribution/sales control unit controls the distribution and sales of the lighting content created by the lighting content creation control unit. The lighting content consumption control unit enables the purchase of the lighting content through the lighting content distribution/sales control unit, provides the lighting content to a user, and receives user evaluation results corresponding to the lighting content from the user.

### CROSS-REFERENCE TO RELATED APPLICATION

This application claims the benefit of Korean Patent Application No. 10-2014-0002476, filed Jan. 8, 2014, which is hereby incorporated by reference herein in its entirety.

### BACKGROUND OF THE INVENTION

1. Technical Field

The present disclosure relates to an apparatus and method for providing lighting content and, more particularly, to an apparatus and method for providing lighting content, which enable lighting content represented using lighting to be freely created and distributed over the Internet, and also enable a general user to easily apply, evaluate and purchase lighting content.

2. Description of the Related Art

Recently, lighting is controlled over a wired or wireless network, as disclosed in Korean Patent Application Publication No. 10-2013-0077503 entitled “Wired/Wireless Infrastructure-based Lighting Control Method and System.” Lighting has evolved into a form that enables brightness to be adjusted, color temperature to be changed and various colors to be rendered thanks to the advent of light-emitting diode (LED) light sources. In line with this trend, recently, research into the emotional effects of LED lighting has been actively carried out, and there have been many actual cases where psychological treatment and the improvement of academic achievement was accomplished utilizing changes in the color temperature of lighting. If replacement with LED lighting is accelerated and the adjustment of brightness, changes in color temperature and variations in color are facilitated, the need and demand for content represented using lighting will dramatically increase.

The range of content that can be represented by LED lighting varies depending on the number of types of LED lighting devices and their control method. For example, in the case of full color LED lighting capable of rendering three colors (red/green/blue), assuming that control is performed using a pulse width modulation method and using eight bits per color, the number of types of content that can be represented is 2⁸×2⁸×2⁸=16,777,216. While the range of content is large as described above, actual marketed products provide only a small variety of content that is provided by manufacturers. The range of content that can be represented using lighting is actually very large as described above. However, lighting content is being created by only a small number of manufacturers or research institutes. Accordingly, the diversification of creation of lighting content is essential for the advent of more varied and better lighting content. Therefore, there is a need for a model for a lighting content business ecosystem in which general users can freely create, distribute and sell lighting content and gain profits and in which lighting content is kept available for consumers or is rendered defunct based on consumer evaluation.

### SUMMARY OF THE INVENTION

Accordingly, at least one embodiment of the present invention is intended to provide an apparatus and method for providing lighting content, which enable lighting content represented using lighting to be freely created and distributed over the Internet and also enable a general user to easily apply, evaluate and purchase lighting content.

In accordance with an aspect of the present invention, there is provided an apparatus for providing lighting content, including a lighting content creation control unit configured to create lighting content; a lighting content distribution/sales control unit configured to control the distribution and sales of the lighting content created by the lighting content creation control unit; and a lighting content consumption control unit configured to enable the purchase of the lighting content through the lighting content distribution/sales control unit, to provide the lighting content to a user, and to receive user evaluation results corresponding to the lighting content from the user.

The lighting content creation control unit may include at least one light unit; and a lighting control unit configured to generate the lighting content through communication with the at least one lighting unit over a lighting network.

The lighting control unit may include an internal network communication unit configured to perform the communication with the at least one lighting unit over the lighting network; a control unit configured to create the lighting content; an input unit configured to receive information required for the creation of the lighting content from a user; and an external network communication unit connected to the Internet of the lighting content distribution/sales control unit.

If the lighting control unit does not include the external network communication unit, it may upload the lighting content to the lighting content distribution/sales control unit using an external terminal over the Internet.

The lighting content distribution/sales control unit may include a database operation unit configured to perform user authentication for the lighting content using an account database, and to store in a database the lighting content for which the user authentication has been completed; a service provision unit configured to provide service that can be provided based on the web; an evaluation unit configured to install and execute a demo version of the lighting content, to receive evaluation from the corresponding user, and to store the received evaluation in an evaluation database through the database operation unit; and a purchasing unit configured to, if the user desires to purchase the lighting content, sell the lighting content and perform billing processing corresponding to the lighting content through a billing processing unit.

The purchasing unit may share the profits of sales of the lighting content with the lighting content creation control unit at a preset ratio.

The lighting content may correspond to content represented using lighting, the lighting content including basic information corresponding to lighting information adapted to include a lighting manufacturer, a manufacturing date and a lighting model name, a lighting method adapted to correspond to one of point lighting, linear lighting, direct lighting and indirect lighting, a lighting space adapted to correspond to a space in which corresponding lighting was installed during creation of the lighting content, and a user description; and specific information corresponding to at least one of color temperature, color, a scene to be represented, luminance, dimming rate, and a specific pattern.

In accordance with another aspect of the present invention, there is provided a method of providing lighting content, including creating, by a lighting content creation control unit, lighting content using lighting, and registering, by the lighting content creating control unit, the created lighting content in a lighting content distribution/sales control unit; managing, by the lighting content distribution/sales control unit, the distribution of the registered lighting content; if a specific consumer desires to purchase the lighting content, requesting, by a lighting content consumption control unit, the purchase of the lighting content from the lighting content distribution/sales control unit; and receiving, by the lighting content distribution/sales control unit, the lighting content corresponding to the request for purchase, and selling, by the lighting content distribution/sales control unit, the lighting content to the consumer.

The selling may include receiving, by the lighting content distribution/sales control unit, evaluation of degree of satisfaction with the lighting content from the consumer, and transferring, by the lighting content distribution/sales control unit, the evaluation of the degree of satisfaction to the lighting content consumption control unit; and determining, by the lighting content consumption control unit, whether to distribute the lighting content based on the evaluation of the degree of satisfaction.

The selling may include sharing profits of sales of the lighting content sold by the lighting content distribution/sales control unit with the lighting content creation control unit at a preset ratio.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating the configuration of an apparatus for providing lighting content according to an embodiment of the present invention;

FIG. 2 is a diagram illustrating a lighting content creation control unit according to an embodiment of the present invention;

FIG. 3 is a diagram illustrating a lighting content marketplace management unit according to an embodiment of the present invention;

FIG. 4 is a diagram illustrating lighting content information according to an embodiment of the present invention;

FIG. 5 is a reference diagram illustrating web-based service according to an embodiment of the present invention; and

FIG. 6 is a flowchart illustrating a method of providing lighting content according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

An apparatus and method for providing lighting content according to embodiments of the present invention are described in detail with reference to the accompanying drawings.

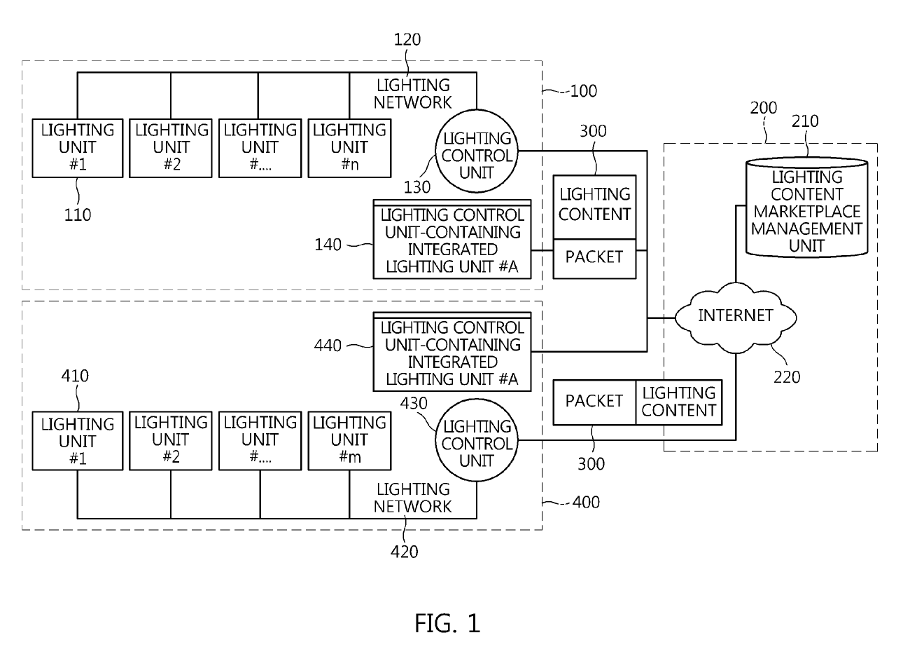

FIG. 1 is a diagram schematically illustrating the configuration of an apparatus for providing lighting content according to an embodiment of the present invention.

First, the term “lighting content” refers to content represented using lighting, for example, brightness, color temperature, color, an individual pattern, a group pattern, time-based representation, etc.

Referring to FIG. 1, the apparatus for providing lighting content includes a lighting content creation control unit 100 configured to create lighting content, a lighting content distribution/sales control unit 200 configured to distribute and sell the created lighting content in the form of, for example, a marketplace, and a lighting content consumption control unit 400 configured to enable a general user to easily install, evaluate and purchase the lighting content. In this case, although the lighting content creation control unit 100 may correspond to a server for creating lighting content, the lighting content distribution/sales control unit 200 may correspond to a server for distributing and selling the created lighting content, and the lighting content consumption control unit 400 may correspond to a server for consuming the lighting content. However, these units are not limited thereto.

The lighting content creation control unit 100 includes lighting units 110, a lighting network 120, a lighting control unit 130, and a lighting control unit-containing integrated lighting unit #A 140.

The lighting content distribution/sales control unit 200 includes a lighting content marketplace management unit 210.

The lighting content marketplace management unit 210 communicates with lighting control units 130 and 430 and lighting control unit-containing integrated lighting units 140 and 440 over the Internet 220. In this case, lighting content information 300 is transmitted and received over the Internet 220.

The lighting content consumption control unit 400 is configured in a form similar to that of the lighting content creation control unit 100, and includes a lighting unit 410, a lighting network 420, a lighting control unit 430, and a lighting control unit-containing integrated lighting unit #B 440.

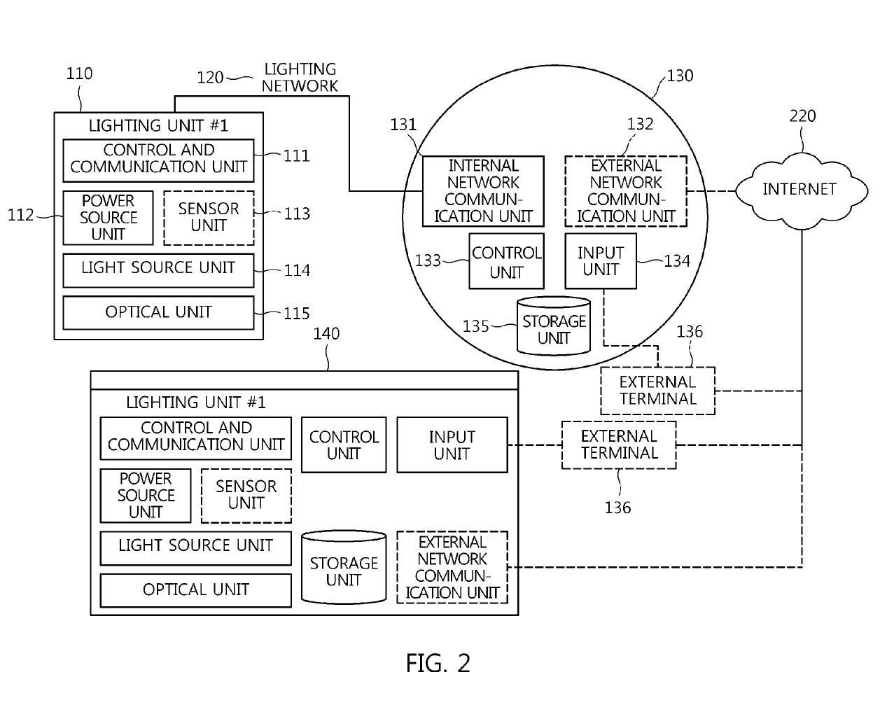

Next, the lighting content creation control unit 100 is described in detail with reference to FIG. 2.

FIG. 2 is a diagram illustrating the lighting content creation control unit 100 according to an embodiment of the present invention.

Referring to FIG. 2, the lighting unit 110 includes a control and communication unit 111, a power source unit 112, a sensor unit 113, a light source unit 114, and an optical unit 115.

The sensor unit 113 obtains information required for an active change in lighting content, for example, illuminance, color, temperature, humidity, human body, detection results, etc.

The light source unit 114 includes one or more LED devices or one or more similar light sources.

The optical unit 115 includes a light diffusion plate and a lens.

The lighting network 120 that connects the lighting units (lighting unit #1 to lighting unit #n of FIG. 1) and the lighting control unit 130 configured as described above may be a commonly used lighting control network, and may correspond to a Digital Addressable Lighting Interface (DALI) network, a Digital Multiplex (DMX) network, an RS-485 network, or an Ethernet.

The lighting control unit 130 includes an internal network communication unit 131 configured to communicate with the lighting units using the lighting network 120, a control unit 133 configured to create lighting content through communication with the lighting units, a storage unit 135 configured to record and store the lighting content information 300, an input unit 134 configured to receive direct input or to receive information required to create lighting content from users using external terminals (for example, a computer, a smartphone, and/or the like) 136, and an external network communication unit 132 configured to connect with the Internet 220.

When the external network communication unit 132 is not provided, the lighting control unit 130 may upload lighting content to the lighting content distribution/sales control unit 200 over the Internet 220 using the connected external terminal 136.

Furthermore, the invention lighting content creation control unit 100 according to an embodiment of the present may also include the lighting control unit-containing integrated lighting unit #A 140 that independently operates without requiring the lighting network 120. In this case, the lighting control unit-containing integrated lighting unit #A 140 corresponds to a lighting unit including components such as the lighting control unit 130.

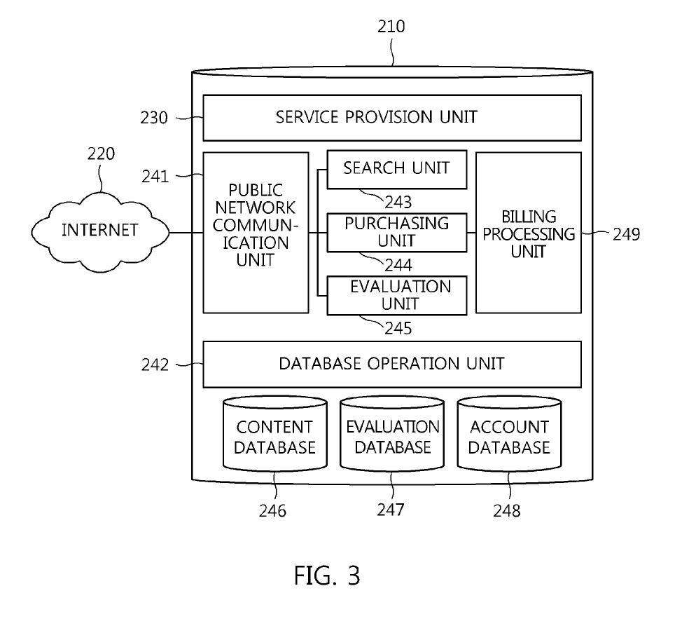

Next, the lighting content marketplace management unit 210 is described in detail with reference to FIG. 3.

FIG. 3 is a diagram illustrating the lighting content marketplace management unit according to an embodiment of the present invention.

Referring to FIG. 3, the lighting content marketplace management unit 210 receives lighting content that is uploaded by the lighting content creation control unit 100 over a public network communication unit 241 connected to the Internet 220.

A database operation unit 242 performs user authentication for the lighting content using an account database 248, and stores the lighting content for which user authentication has been completed in a content database 246.

A service provision unit 230 provides web-based service, for example, the service of enabling another user to perform a search or download. In this case, when a user desires a search for specific lighting content, the service provision unit 230 operates in conjunction with a search unit 243.

A evaluation unit 245 installs and executes a demo version of the lighting content, receives evaluation from a corresponding user, and stores the received evaluation in an evaluation database 247 through the database operation unit 242. Thereafter, the content database 246 and the evaluation database 247 are databases associated with each other, and may be searched for lighting content.

A purchasing unit 244, when a user desires to purchase lighting content, sells lighting content, and performs billing processing corresponding to the lighting content through a billing processing unit 249. In this case, the billing processing unit 249 shares the profits of the sales of the lighting content with the creator of the lighting content at an agreed ratio.

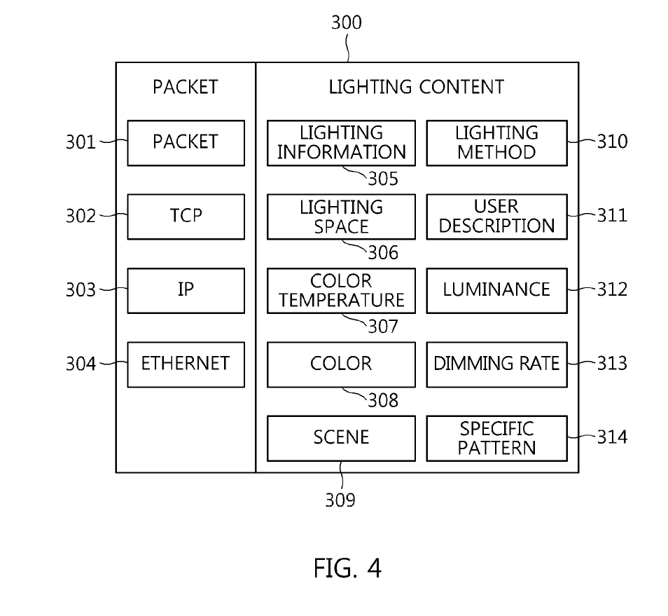

Next, the lighting content information 300 is described in detail with reference to FIG. 4.

FIG. 4 is a diagram illustrating the lighting content information 300 according to an embodiment of the present invention.

Referring to FIG. 4, lighting content information 300 includes a packet and lighting content.

The packet 301 complies with internationally-standardized protocols, such as the Ethernet 304, the Internet Protocol (IP) 303, and the Transmission Control Protocol (TCP) 302, corresponding to Ethernet protocols that are used to transmit and receive the lighting content information 300 over the Internet 220.

The lighting content may include: basic information, corresponding to lighting information 305 adapted to include a lighting manufacturer, a manufacturing date and a lighting model name and, a lighting method 310 configured to correspond to one of point lighting, linear lighting, direct lighting or indirect lighting, a lighting space 306 configured to correspond to a space in which corresponding lighting was installed during the creation of lighting content, and a user description 311; and specific information corresponding to at least one of color temperature 307, color 308, a scene 309 to be represented, luminance 312, dimming rate 313 and a specific pattern 314, which includes numerical values required for direct lighting control.

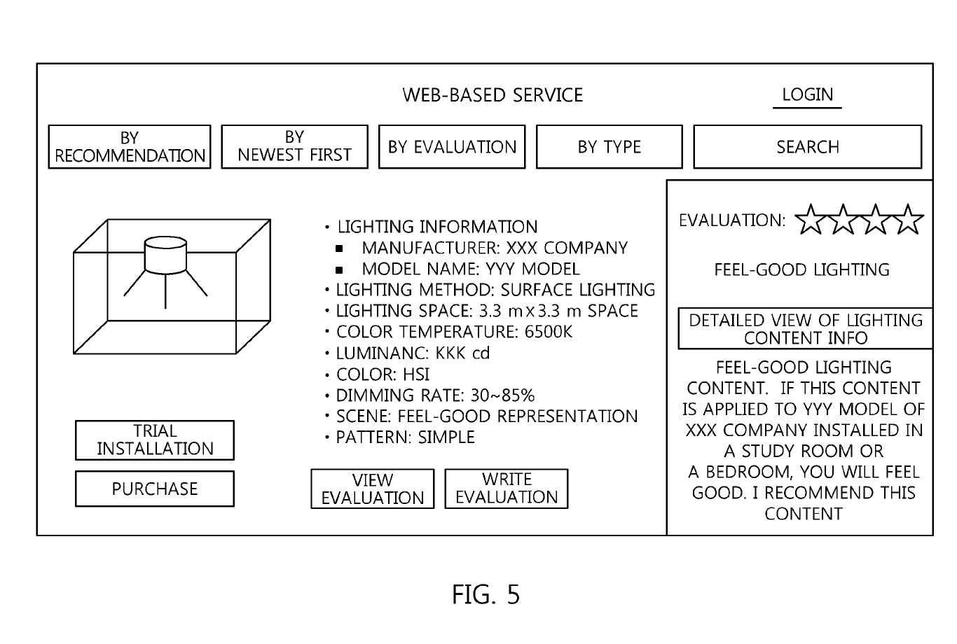

Next, the web-based service that is provided by the service provision unit 230 is described in detail with reference to FIG. 5.

FIG. 5 is a reference diagram illustrating web-based service according to an embodiment of the present invention.

The service provision unit 230 may provide web-based service, as illustrated in FIG. 5. The content and configuration illustrated in FIG. 5 are intended to help the understanding of an embodiment of the present invention, and the content and configuration of the web-based service is not limited thereto.

Referring to FIG. 5, the lighting content registered by creators may be classified and listed according to various classification methods, for example, in recommendation order, by newest first, in evaluation order, and by type.

The service provision unit 230 provides a search function to a user, thereby providing lighting content suitable for desired conditions to the user. Furthermore, when a user desires a search for specific lighting content, the service provision unit 230 provides corresponding lighting content and corresponding user evaluation.

After the user has logged in via the web-based service, he or she may install lighting content on a trial basis, that is, is provided with lighting content, and may then evaluate the lighting content. Thereafter, the user may pay for and purchase the lighting content via a purchase button.

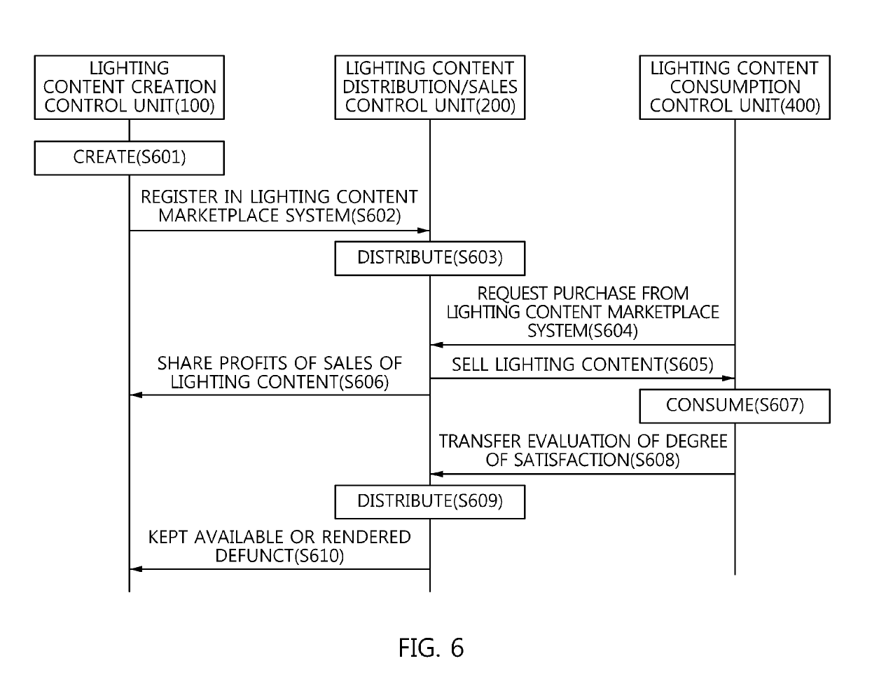

Thereafter, a method of providing lighting content is described in detail with reference to FIG. 6.

FIG. 6 is a flowchart illustrating a method of providing lighting content according to an embodiment of the present invention.

First, the apparatus for providing lighting content includes the lighting content creation control unit 100 configured to create lighting content, the lighting content distribution/sales control unit 200 configured to distribute and sell the created lighting content in the form of, for example, a marketplace, and the lighting content consumption control unit 400 configured to enable a general user to easily install, evaluate and purchase the lighting content.

Referring to FIG. 6, the lighting content creation control unit 100 generates content represented using lighting, for example, brightness, color temperature, color, an individual pattern, a group pattern, time-based representation, etc. at step S601.

The lighting content distribution/sales control unit 200 registers the lighting content created at step S601 in the lighting content marketplace management unit 210 at step S602.

The lighting content distribution/sales control unit 200 manages the distribution of the lighting content managed by the lighting content marketplace management unit 210 at step S603.

When a consumer desires to purchase lighting content, the lighting content consumption control unit 300 requests the purchase of lighting content managed by the lighting content marketplace management unit 210 from the lighting content distribution/sales control unit 200 at step S604.

The lighting content distribution/sales control unit 200 sells the lighting content corresponding to the request received at step S604 to the consumer through the lighting content consumption control unit 300 at step S605.

Then the lighting content distribution/sales control unit 200 shares the profits of the sales of the lighting content sold at step S605 with the lighting content creation control unit 100 at a preset ratio at step S606.

The lighting content consumption control unit 300 performs control so that the consumer uses the lighting content, purchased at step S605, at step S607, and then receives the evaluation of the degree of satisfaction with the lighting content from the consumer and transfers the evaluation of the degree of satisfaction to the lighting content distribution/sales control unit 200 at step S608.

The lighting content distribution/sales control unit 200 determines whether to distribute the lighting content based on the results of the evaluation of the degree of satisfaction with the lighting content at step S609. Furthermore, the lighting content distribution/sales control unit 200 notifies the lighting content creation control unit 100 of the results of the determination of whether to distribute the lighting content, that is, whether the lighting content is kept available for consumers or is rendered defunct, at step S610.

The apparatus and method for providing lighting content according to at least one embodiment of the present invention has the advantages of enabling lighting content represented using lighting to be freely created and distributed over the Internet and also enabling a general user to easily apply, evaluate and purchase the lighting content, thereby promoting the development of the lighting content market and thus maximizing the utilization of lighting indispensible to human life.

Furthermore, the apparatus and method for providing lighting content according to at least one embodiment of the present invention has the advantage of establishing the lighting content market in which lighting content can be freely created and evaluated, thereby constructing an active business ecosystem in which lighting content is kept available for consumers or is rendered defunct based on consumer evaluation. This results in the active development of lighting content.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for providing lighting content, comprising:
a lighting content creation control unit configured to create lighting content;
a lighting content distribution/sales control unit configured to control distribution and sales of the lighting content created by the lighting content creation control unit; and
a lighting content consumption control unit configured to enable purchase of the lighting content through the lighting content distribution/sales control unit, to provide the lighting content to a user, and to receive user evaluation results corresponding to the lighting content from the user.

2. The apparatus of claim 1, wherein the lighting content creation control unit comprises:
at least one light unit; and
a lighting control unit configured to generate the lighting content through communication with the at least one lighting unit over a lighting network.

3. The apparatus of claim 2, wherein the lighting control unit comprises:
an internal network communication unit configured to perform the communication with the at least one lighting unit over the lighting network;
a control unit configured to create the lighting content;
an input unit configured to receive information required for the creation of the lighting content from a user; and
an external network communication unit connected to the Internet of the lighting content distribution/sales control unit.

4. The apparatus of claim 3, wherein the lighting control unit, if it does not include the external network communication unit, uploads the lighting content to the lighting content distribution/sales control unit using an external terminal over the Internet.

5. The apparatus of claim 1, wherein the lighting content distribution/sales control unit comprises:
a database operation unit configured to perform user authentication for the lighting content using an account database, and to store in a database the lighting content for which the user authentication has been completed;
a service provision unit configured to provide service that can be provided based on the web;
an evaluation unit configured to install and execute a demo version of the lighting content, to receive evaluation from the corresponding user, and to store the received evaluation in an evaluation database through the database operation unit; and
a purchasing unit configured to, if the user desires to purchase the lighting content, sell the lighting content and perform billing processing corresponding to the lighting content through a billing processing unit.

6. The apparatus of claim 5, wherein the purchasing unit shares profits of sales of the lighting content with the lighting content creation control unit at a preset ratio.

7. The apparatus of claim 1, wherein the lighting content corresponds to content represented using lighting, the lighting content comprising:
basic information corresponding to lighting information adapted to include a lighting manufacturer, a manufacturing date and a lighting model name, a lighting method adapted to correspond to one of point lighting, linear lighting, direct lighting and indirect lighting, a lighting space adapted to correspond to a space in which corresponding lighting was installed during creation of the lighting content, and a user description; and
specific information corresponding to at least one of color temperature, color, a scene to be represented, luminance, dimming rate, and a specific pattern.

8. A method of providing lighting content, comprising:
creating, by a lighting content creation control unit, lighting content using lighting, and registering, by the lighting content creating control unit, the created lighting content in a lighting content distribution/sales control unit;
managing, by the lighting content distribution/sales control unit, distribution of the registered lighting content;
if a specific consumer desires to purchase the lighting content, requesting, by a lighting content consumption control unit, purchase of the lighting content from the lighting content distribution/sales control unit; and
receiving, by the lighting content distribution/sales control unit, the lighting content corresponding to the request for purchase, and selling, by the lighting content distribution/sales control unit, the lighting content to the consumer.

9. The method of claim 8, wherein the selling comprises:
receiving, by the lighting content distribution/sales control unit, evaluation of degree of satisfaction with the lighting content from the consumer, and transferring, by the lighting content distribution/sales control unit, the evaluation of the degree of satisfaction to the lighting content consumption control unit; and
determining, by the lighting content consumption control unit, whether to distribute the lighting content based on the evaluation of the degree of satisfaction.

10. The method of claim 8, wherein the selling comprises sharing profits of sales of the lighting content sold by the lighting content distribution/sales control unit with the lighting content creation control unit at a preset ratio.
